(19) United States
(12) Patent Application Publication
(10) Pub. No.: US 2015/0058232 A1
(43) Pub. Date: Feb. 26, 2015

(54) Integrated Computer-Assisted Investigative Systems

(71) Applicants: James B. Persinger, Atlanta, GA (US); Evelyn K. Bishop-Persinger, Atlanta, GA (US)

(72) Inventors: James B. Persinger, Atlanta, GA (US); Evelyn K. Bishop-Persinger, Atlanta, GA (US)

(21) Appl. No.: 14/465,601

(22) Filed: Aug. 21, 2014

Related U.S. Application Data
(60) Provisional application No. 61/868,202, filed on Aug. 21, 2013.

(51) Int. Cl. G06Q 50/18; G06Q 10/00

(52) U.S. Cl. CPC G06Q 50/18; G06Q 10/00
USPC 705/311

(57) ABSTRACT

Investigative systems and methods are provided. A representative system incorporates a memory comprising a first executable code; and a first processor configured to execute the first executable code to: selectively perform data access from a plurality of events based on execution of the first executable code, wherein the data access corresponds to sequential image capture of the plurality of events using multiple instances of simultaneously executing capture windows. A representative method comprises: executing a single instance of an executable file; and selectively accessing data from a plurality of events based on execution of executable code of the executable file wherein the data corresponds to sequential image capture of the plurality of events using multiple instances of simultaneously executing image capture windows.

### CROSS-REFERENCE TO RELATED APPLICATION

This utility application claims the benefit of and priority to U.S. Provisional Application 61/868,202, filed on Aug. 21, 2013, which is incorporated by reference herein in its entirety.

### TECHNICAL FIELD

The present disclosure is generally related to computer systems, and, more particularly, to computer-assisted investigative systems.

### BACKGROUND

When using the Internet for investigative evidence, such as in cyber crime, there exists an inherent problem with (1) reporting (e.g., investigators consume a considerable amount of time and energy in preparing reports based on a patchwork of evidence), and relatedly, (2) reliance by investigators on several different and separate utilities (e.g., to perform data logging or note taking, such as through a text editor, perform video capture or screen capture, etc.) to support a given case. The use of separate and distinct utilities may create inefficiencies in performing investigative work and/or report generation of the same. In addition, when the case goes to court, such separate and distinct utilities may raise questions as to the integrity of the data used as evidence (e.g., its authenticity, whether the data represents a complete picture of the criminal activity and corresponding investigation, etc.), possibly jeopardizing a case years in the making among several agencies and/or consuming investigator time in supplementing the investigative record or evidence that otherwise may have been avoidable had the data been collected with more integral, integrated or flexible procedures.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an embodiment of a computer assisted investigative system for performing keystroke recording, which illustrates only a portion of the computer assisted investigative system

FIG. 2 is a block diagram of an embodiment of a computer assisted investigative system for performing keystroke recording, which illustrates only a portion of the computer assisted investigative system.

FIG. 3 is a block diagram of an embodiment of a computer assisted investigative system for performing keystroke recording, which illustrates only a portion of the computer assisted investigative system.

FIG. 4 is a block diagram showing a conventional system for performing keystroke recording.

FIG. 5 is a block diagram of an embodiment of a computer assisted investigative system for performing rapid, repetitive image captures that are uniquely processed and converted into a video and which illustrates only a portion of the computer assisted investigative system.

FIG. 6 is a block diagram of an embodiment of a computer assisted investigative system for performing network-based rapid, repetitive image captures that are uniquely processed and converted into a video and which illustrates only a portion of the computer assisted investigative system.

FIG. 7 is a block diagram of an embodiment of a computer assisted investigative system for performing network-based rapid, repetitive image captures that are uniquely processed and converted into a video and which illustrates only a portion of the computer assisted investigative system.

FIG. 8 is a block diagram of an embodiment of a computer assisted investigative system for performing covert short message service (SMS) and which illustrates only a portion of the computer assisted investigative system.

FIG. 9 is a block diagram of an embodiment of a computer assisted investigative system for performing covert SMS and which illustrates only a portion of the computer assisted investigative system.

FIG. 10 is a block diagram of an embodiment of a computer assisted investigative system for performing covert SMS and which illustrates only a portion of the computer assisted investigative system.

FIG. 11 is a block diagram of an embodiment of a computer assisted investigative system for performing covert Linked Media Service (LMS) and which illustrates only a portion of the computer assisted investigative system.

FIG. 12 is a block diagram of an embodiment of a computer assisted investigative system for performing covert LMS and which illustrates only a portion of the computer assisted investigative system.

FIG. 13A is a block diagram of an embodiment of a computer assisted investigative system for performing covert LMS and which illustrates only a portion of the computer assisted investigative system.

FIG. 13B is a diagram of a representative graphical user interface that may be used in an embodiment of a computer assisted investigative system.

FIG. 14 is a block diagram of an embodiment of a computer assisted investigative system for performing resource tracking and which illustrates only a portion of the computer assisted investigative system.

FIG. 15 is a block diagram of an embodiment of a computer assisted investigative system for performing resource tracking and which illustrates only a portion of the computer assisted investigative system.

FIG. 16 is a block diagram of an embodiment of a computer assisted investigative system for performing resource tracking and which illustrates only a portion of the computer assisted investigative system.

FIG. 17 is a block diagram of an embodiment of a computer assisted investigative system for performing a grid monitoring service and which illustrates only a portion of the computer assisted investigative system.

FIG. 18 is a block diagram of an embodiment of a computer assisted investigative system for performing a grid monitoring service and which illustrates only a portion of the computer assisted investigative system.

FIG. 19 is a block diagram of an embodiment of a computer assisted investigative system for performing activity monitoring and which illustrates only a portion of the computer assisted investigative system.

FIG. 20 is a block diagram of an embodiment of a computer system configured to implement a computer assisted investigative system.

FIG. 21 is a flow diagram of an embodiment of a computer assisted investigative method.

### DETAILED DESCRIPTION OF EXAMPLE EMBODIMENTS

Certain embodiments of a computer assisted investigative system and method are disclosed that integrate several utilities for performing and reporting an investigation (e.g., criminal or civil investigation). As set forth in the description below, one embodiment of a computer assisted investigative system comprises a single running instance of an executable file (though plural instances may be used in a given environment in some embodiments) that performs monitoring and recording of one or more events in parallel, with data access (e.g., receipt or extraction of data over a wired and/or wireless medium) achieved according to selective and multiple instances of one or more of the following: key stroke recording, rapid, repetitive image captures (e.g., including network-based as described below), covert short message service (SMS) and linked media service (LMS), resource tracking, monitor screen grid monitoring (also referred to herein as “watchdog services”), activity monitoring, hide and spy, or validation image scanning.

Digressing briefly, as indicated in the background, current systems employ multiple and separate utilities to achieve monitoring in a criminal or civil investigation, which results in inherent inefficiencies, particularly when necessitating the need to capture multiple windows on a single computer monitor or multiple monitors at the same time by using a single process, perform screen capturing, and creating reports to document the evidence and/or investigation process. Also, current technology may require a multitude of steps in a post-activity session (e.g., after a screen capture event) to edit the captured images, insert important contextual information (e.g., date, name, case number, etc.), format, and then store the evidence, without reporting or authentication mechanisms or methodologies. In addition, there are limits to existing technology that arise from the use of separate and distinct utilities, such as in the amount of video capture. For instance, current technology for video capture, permits only one video at a time for a given agent to be launched, and/or is captured in an all or none type of fashion (e.g., capture the entire desktop or none of the desktop) from any one single application. If monitoring several suspects using a single running instance, one of the suspects may not be of interest at a given time, yet is included as part of the recorded capture (which raises questions at trial as to the reasons or motivation behind discounting one suspect over another), among other problems and shortcomings with the all or none approach. Further, video editing techniques today are complicated, and hence, largely go unused, not to mention issues that are raised when a video is edited from an evidentiary point of view.

To counter the aforementioned shortcomings and evidentiary issues, among others, certain embodiments of a computer assisted investigative system are disclosed that provide an integrated investigative and reporting approach that is easy to use and is inherently self-authenticating. In some embodiments, the ability to work with and/or access data that is online (e.g. happening right now as opposed to happened in the past), offline (e.g. seized equipment with no connection to the Internet or network) and real-time (e.g. SMS that is stored and automatically added to the case while it is shared in real-time with each Agent that is part of the investigation) may be realized. As such, through use of simultaneously executing instances, an online case may be conducted with one running instance, an offline case may be conducted by executing another running instance, and a real-time case (i.e., current interaction with a target) may be conducted by executing yet another running instance. A similar scenario of executing multiple running instances could include two or more online cases occurring simultaneously while an off-line case is being examined or any combination thereof.

Having summarized certain features of computer assisted investigative systems of the present disclosure; reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on criminal investigative systems, though it should be appreciated that some embodiments of computer assisted investigative systems may be used in other industries or civil investigations where monitoring and/or report generation of the evidence and/or investigative process is used, and hence are contemplated to be within the scope of the disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

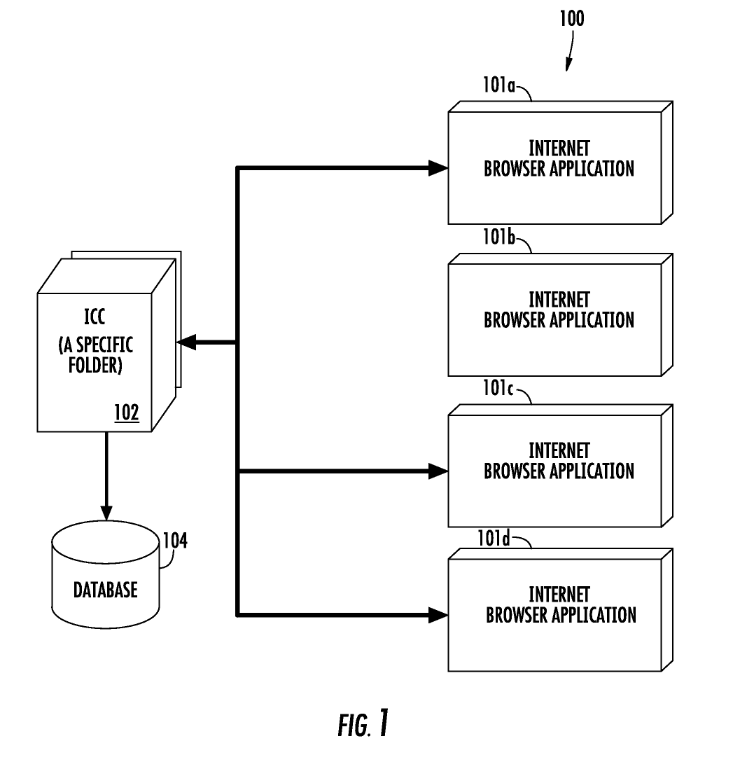

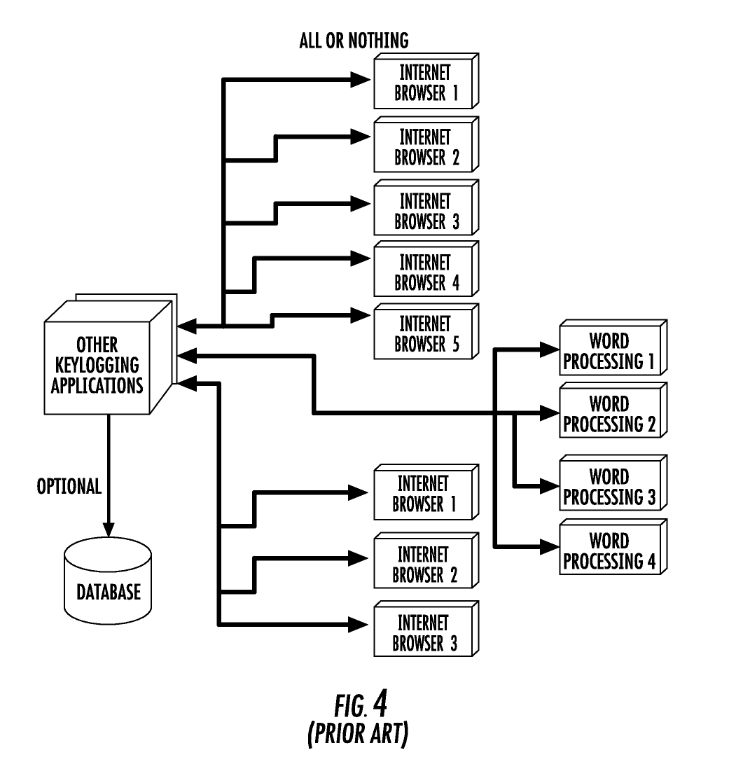

FIGS. 1 through 3 comprise block diagrams of certain embodiments of a computer assisted investigative system for performing keystroke recording. It should be appreciated within the context of the present disclosure that, although certain features are shown in these and later figures using various computer configurations, some embodiments may utilize other configurations with fewer or additional components, and hence are contemplated to be within the scope of the disclosure. In general, conventional key logging systems are based on an all or none approach, as shown in FIG. 4. In contrast, one or more embodiments of a computer assisted investigative system perform multiple instances of key stroke recording that can be run within a single instance of an executable file (e.g., also referred to as CATIE in the figures), where different software applications can be key stroke recorded independent of other applications that are running. For instance, the user (also referred to herein as an agent or investigator, and used hereinafter in the masculine sense with the understanding that the user may be female or male) may pick and choose what he wants to record (inside the executable file), and the executable key stroke recording process does not apply to activities or applications operating outside of the executable file. Key stroke recording, in one embodiment, may be globally set inside the executable to run one or more applications so that when key stroke recording is activated, the globally set application is automatically recorded without the need for a user to interface with the computer assisted investigative system to set the same.

Referring to FIGS. 1 through 3, keystroke recording is also referred to herein as processes. For instance, using a task manager, one can select Notepad or other text editors, which may have individual processes associated with it. As more of these processes operate on a screen, the harder it is to follow which process is being recorded. To address the possible confusion, an embodiment of a computer assisted investigative system enables a user to configure Notepad (or other applications) through a global settings interface. In some embodiments, once the case is opened, Notepad may be added to the open case. Using a quantity of two instances of Notepad as an example illustration, one instance may be used to replicate (e.g., record) the keystrokes and the other instance may be used to enter private notes. Upon highlighting one of the listed instances on a screen, it comes forward and the user knows that instance to be the one for, say, recording. The main screen for performing many of the functions described herein is referred to as the Interactive Command Center (ICC). Users often return to the ICC screen when working a case. For instance, in one embodiment (see, e.g., Exhibit A of the priority application, incorporated herein by reference, there exists a main screen that serves as an interface to the database before the ICC screen comes up. The ICC screen is where a user manages key stroke recording, rapid, repetitive image capture, etc. on a case by case basis, whereas the screen prior to that shows a list of all of the cases within the instance of the software. When the investigative software is launched, a user may type in his or her password. If changes need to be made to something, the user may access settings and/or the global settings and make changes. Once changed, the user selects and opens (e.g., double clicks) on a case, or starts a case, and that process takes the user to the ICC.

The computer assisted investigative system comprises a built-in keystroke recording form. Responsive to being activated, all typing using a text editor such as Notepad, for instance, is recorded into the computer assisted investigative system and also presented on a screen (or optionally not displayed on a screen). Whatever is typed—everything from backspaces, shifts, field searching, etc.—is recorded into the system, providing a built-in chain of custody and/or self-authentication mechanism. The computer assisted investigative system enables the recording of various software applications, such as via Internet Browser application (Internet Explorer, FireFox, and/or other Internet browser software), Notepad, Word, etc. Once a shortcut has been placed on the desktop by the user, each application can be easily added to the keystroke recording process largely due to the computer assisted investigative system being capable of converting the actual path of where the application is actually installed on the user's computer into a shortcut. Note that most conventional key loggers are all or none—the system either captures everything or captures nothing. In contrast, certain embodiments of a computer assisted investigative system enable a user to selectively choose which application and which process (e.g., notepad, IE) of that application (e.g., 1 of 3, 2 of 3, etc.) that is running within that case. So, it is by instance (of the executable running) and can change by case.

Note that the global settings apply globally to every case once set. But within each individual case, the user can key record the specific application for that case, a function that may be turned on or off on-the-fly (e.g., another difference when compared to conventional systems). For instance, in existing systems, only one instance is run to perform video recording. Referring specifically to FIG. 1, an example embodiment of a computer assisted investigative system 100 is depicted in which there are four instances of Internet Explorer (IE) (101A-101D). Notably, three of these instances (i.e., 101A, 101C and 101D) have been selected as being subject to key recording. For instance, on a given screen, there may be four quadrants for each of the four IE instances, and the user may choose not to monitor one of the instances (e.g., where the user has decided to perform Internet research for that turned-off quadrant and does not wish to record the research). Note that reference herein to an instance refers to each instance of the IE running within one case's ICC instance (e.g., ICC instance 102) and, hence, one instance of the executable CATIE file running. Note that reference to CATIE is equivalent to reference to the executable (e.g., catie.exe). Also, reference to the ICC is a form that is generated within the executable. In some embodiments, multiple copies of the CATIE executable file and each executable respective case' ICC (e.g., two instances of the executable running at the same time) may be run, unlike conventional systems. In some embodiments, up to twenty (20) different instances of the CATIE executable file (and respective ICCs) may be running at the same time, with additional or fewer running in other embodiments. To be more precise, multiple instances can be run of the CATIE executable file simultaneously, with each executable file running one or more instances of the ICC, which, in turn, is/are recording one or more instances (or sessions) of any video recording, key stroke recording, activity monitoring, etc. session or activity. All of which is simultaneously recording, storing, logging, etc. to one centralized database (e.g., database 104). Further information may be found in Exhibit B, incorporated herein by reference, of the priority application.

In environments where multiple monitor screens are used, the user can put one instance of the ICC on each one of the corresponding monitor screens, with the data recording functions (e.g., including screen capture) enabled for each and therefore can be capturing information or evidence for each case separately or for a single case or any combination thereof.

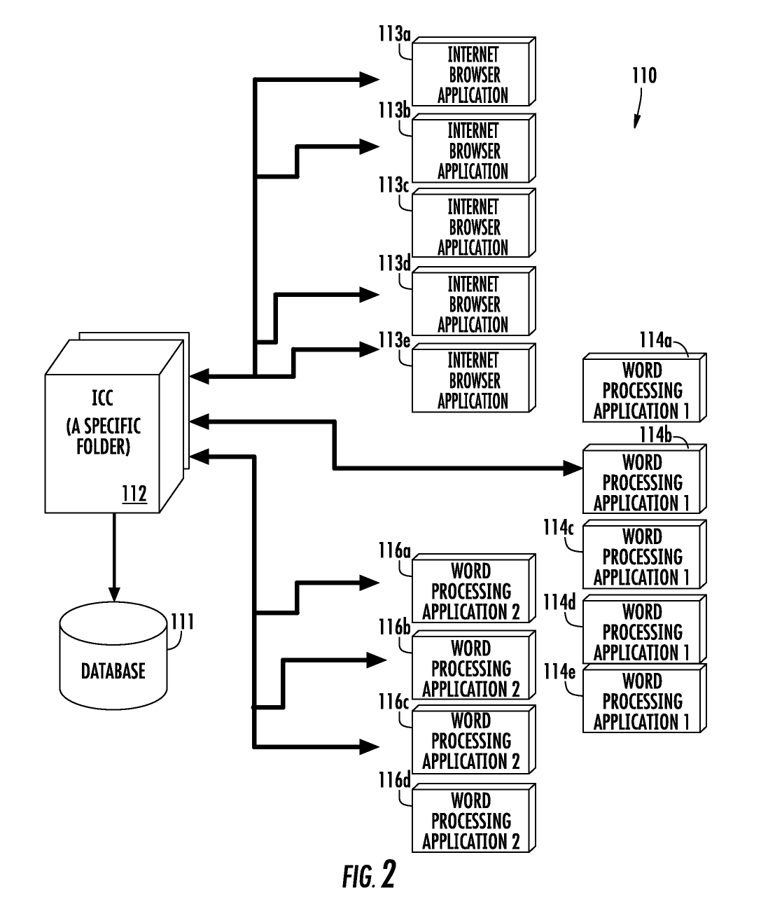

Referring specifically to FIG. 2, FIG. 2 is a block diagram of an embodiment of a computer assisted investigative system 110 for performing keystroke recording to a database 111 using an ICC 112. In FIG. 2, what is illustrated as being monitored (selectively) for keystroke recording are instances of IE (113A-113E), Notepad (114A-114E), and Field Search (116A-116D). Whatever is configured as a source for monitoring a given event (e.g., key stroke recording for one or more software applications) can then be recorded in certain embodiments of the computer assisted investigative system. Note that the Notepad (Microsoft Word) set of applications only has one running process in the depicted example. In other words, if there is no recording, there is nothing happening (e.g., no “logging”). However, for those running (those without the slash through the application identifier in the figure), even pauses in the recording are recorded. Note that these processes are implemented in FIG. 2 for a single instance of the executable.

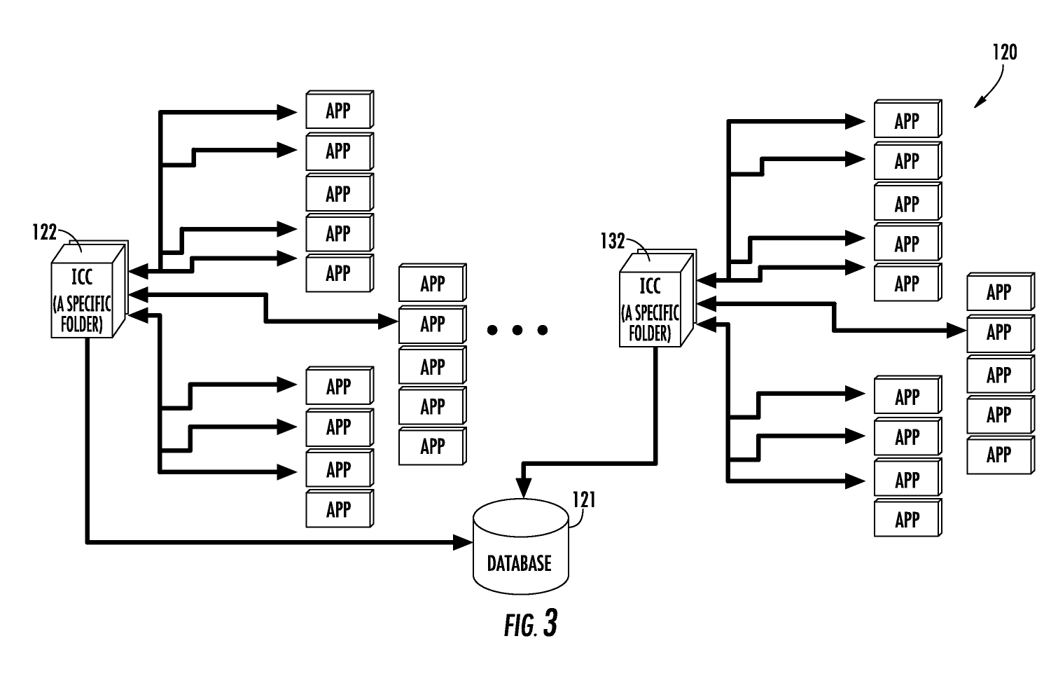

In FIG. 3, an embodiment of a computer assisted investigative system 120 is shown in which multiple instances of the executable and respectively the ICC (122 and 132) are running, though the data accessed is all collected in the same database 121. In the example depicted in FIG. 3, each instance of the ICC is linked to a single case, and all information that is captured through the respective ICC is stored and referenced relative to that case.

Referring to FIG. 4, shown is a conventional system, illustrating an all or none key logging process, without the selectivity (e.g., in preventing one of the instances of applications from being logged) found in certain embodiments of the computer assisted investigative system. In particular, as depicted, all instances running are being recorded.

In some embodiments, as described further in Exhibit A of the priority application (incorporated herein by reference in its entirety), profiling is facilitated in the computer assisted investigative system. In general, law enforcement never (or rarely) knows what kind of case they will get involved with at any given instance in time. One case might be associated with computers, another may deal with mortgage fraud, another may deal with on-line identity theft, and another may deal with cyber stalking. A “fake” profile is often created as part of an investigator's case. However, in the past, an investigator might create a profile and then forget some of the details about it because there is no “responsive mechanism” to track or revisit such fake profile details, excluding the proverbial pen and paper method. When tested by a suspect (e.g., to see if the person he or she is communicating with is law enforcement), the suspect may ask, “So you were a track star in high school?” whereas previously the investigator said he was a cheerleader. In certain embodiments of computer assisted investigative systems, through minimization tools of a screen, the investigator may display profiles at his or her ready. Also, because the computer assisted investigative systems enable selective recording, faux profiles need not be recorded as part of the screen capture. The faux profile may be detached from the ICC via a “floating, moveable panel” which can continue to operate even though the ICC has been minimized to help reduce clutter on the desktop. In addition, the profiles may be exported out and imported in according to certain functionality (such as described further in Exhibit A), as opposed to capturing, via screen shot, the profile and sending via email to one or more people (though some embodiments may use such approaches as well).

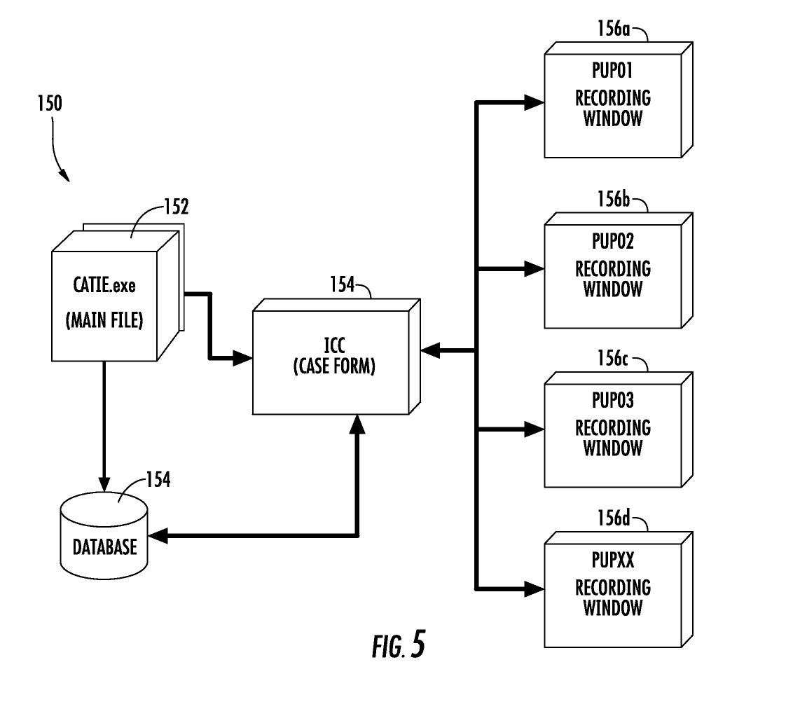

FIGS. 5 through 7 show various embodiments for performing rapid, repetitive image capture (hereinafter defined and referred to as “Video capture”). Video capture is also referred to herein as video pups (where pups are also known as pop up programs). In certain embodiments of a computer assisted investigative system, multiple recording windows “pups” may be launched simultaneously. Such video capture is not really video capturing in the streaming sense, but rather, computer assisted investigative processes create screen captures at such high speeds that it appears to be a video and is uniquely processed as a video, merged and saved into a video format. This primary method is used to reduce processor overhead while remaining productive. In some embodiments, however, streaming capture may be used. Multiple recording windows can be run at the same time within one instance of the running executable. Each recording window may capture an independent video or activity (or generally, an event), which is stored in a folder within the executable. Any one or more of the recording windows may be monitored and each single pup permits image frame extraction and places the image frame extracted into the case folder without interaction from the user.

As shown in FIG. 5, a block diagram of an embodiment of a computer assisted investigative system 150 is depicted. In particular, system 150 includes a main file 152 and an ICC 154 that interact to provide data to a database 154. The captured data in this embodiment is provided by multiple video pups (156A-156D). Each one of the video pups is a video capturing window (e.g., the recording window), and the pups are selectively activated (and may be grouped in some embodiments, where grouped video pups may be moved in unison (though started and stopped individually, or rather, independently recorded)). Thus, a single instance of CATIE provides multiple instances of video capture windows. Notably, a video pup is not a program and cannot be run by itself.

Digressing briefly, existing systems perform one single video capture at a time which can be of the entire monitor screen, a selected region on the monitor screen, or a window on the monitor screen from only one single running instance and requires pre and post activity interaction by the user for editing, naming, saving, etc. Certain embodiments of computer assisted investigative systems have tiers of capability based on a given licensing scheme. For instance, the number of recording windows may fall under different capabilities or quantities based on the licensing scheme (e.g., Basic equals 3, Premium equals 20, etc.).

In addition, certain embodiments of computer assisted investigative systems allow the user to assign hotkeys which may enable a user to activate the desired quantity of video pups, and a time indicator (e.g., elapsed time) provides an indication of the size of the recording. Frame capture can also be performed (with automatic, user defined-text editing, object drawing to highlight certain portions of the video, object drawing to redact certain portions of the video, etc.). In some embodiments, the video may follow the object to be focused on in the video as the suspect moves. Recall that conventional systems only enable a single video recording. Also, additional functionality of certain embodiments may include features that enable window sizes to be changed, a cursor added, a recording delayed, audio captured, and/or locking with a given app (e.g., with Notepad). Additional functionality includes enabling overlays (e.g., typically text or images), stamping the video being recorded with the system time to remove questions of authenticity, and/or adding watermarks (e.g., using built-in templates to show where text (watermark) will show up, a feature not present in conventional systems).

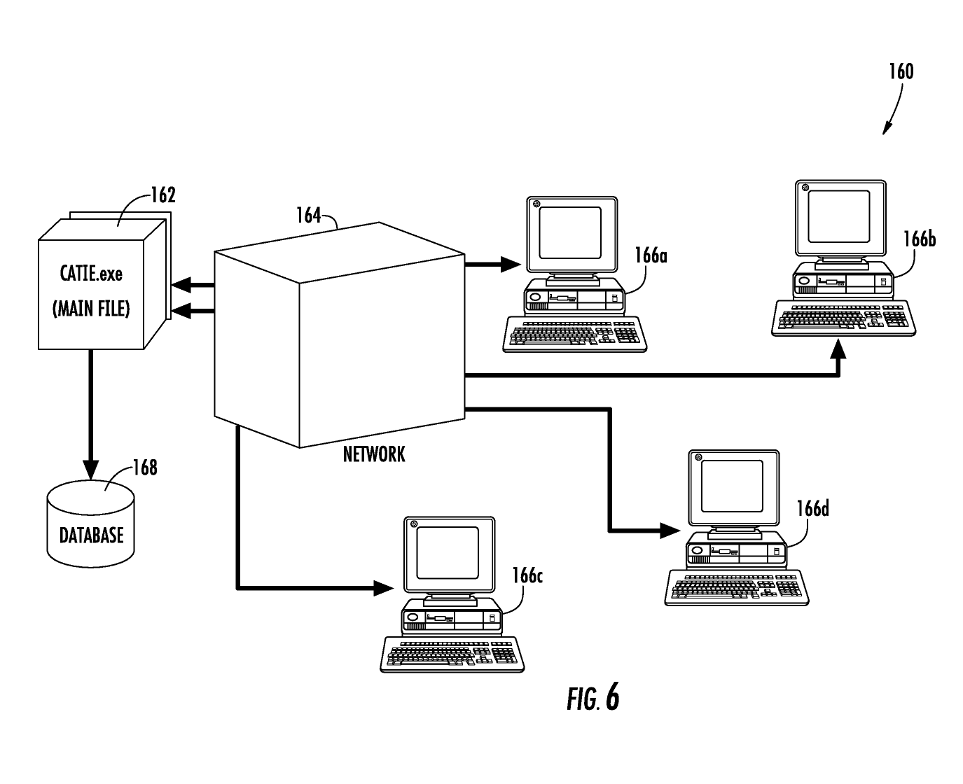

In some implementations, a given agency may have old and/or slow computers (and/or video cards). Depending on the applied license scheme associated with the computer assisted investigative system, a user or an agency may have the ability, or at least the right, to run fifty (50) video pups on other computers using the same network. Referring to FIG. 6, certain embodiments of computer assisted investigative systems (e.g., system 160) may run a video recording window for video recording of other computer monitors on the same network; referred to herein as network pups (NetPUP or simply, netpup), where a computer different than the one running the executable runs the netpups. In general, a netpup enables monitoring of activities on other computers on the same network and reports back to the main computer housing the executable and database file (or controlling the database file). Text, SMS, voice, radio, email, and/or hand gestures (e.g., as identified via webcam), among other communication means, may be used to start and stop a netpup, and information collected is automatically transferred back across the network to the case folder maintained on the main computer housing the executable and database file (or controlling the database file).

In FIG. 6, the main executable 162 runs through the ICC window (not shown), and the pups are run through a network 164 that the executable controls. If the executable is accessed from another computer, the pups that are active may be shown. If the user wants to see the video on a remote computer (166A-166D) not running the executable), the user may view the video. As long as the computer is in a given internal network (e.g., it does not matter if the network expands to more than one building—as long as VPN is available), the user can view the netpup. Indeed, as many computers as desired may be employed, each one running from the executable. For instance, the services of the network (e.g., LAN) are enabled, the netpup clients are enabled, and wherever the application is running it shows up in a window. Responsive to selection (e.g., double clicking), the user can now see everything on that computer and that video, and he can actually control the entire computer. While monitoring the video, the user may desire to launch Firefox (e.g., the suspect says he is using FireFox, prompting a change by the user). The user may use netpup to remote control that PC and start any program on there which then becomes visible inside the netpup. Once completed, the recorded video is transferred to the case folder within the database 168 automatically. Existing systems, to employ multiple computers, need to manually transfer any such recordings using a thumb drive (or similar external storage device) or across the network to the main computer by using manual efforts. In some embodiments, using netpup, the user can use his cell phone (or other electronic appliance, device or mechanism) to start or stop the recording, and/or retrieve screen captures for observation on the phone (with possible importation if needed).

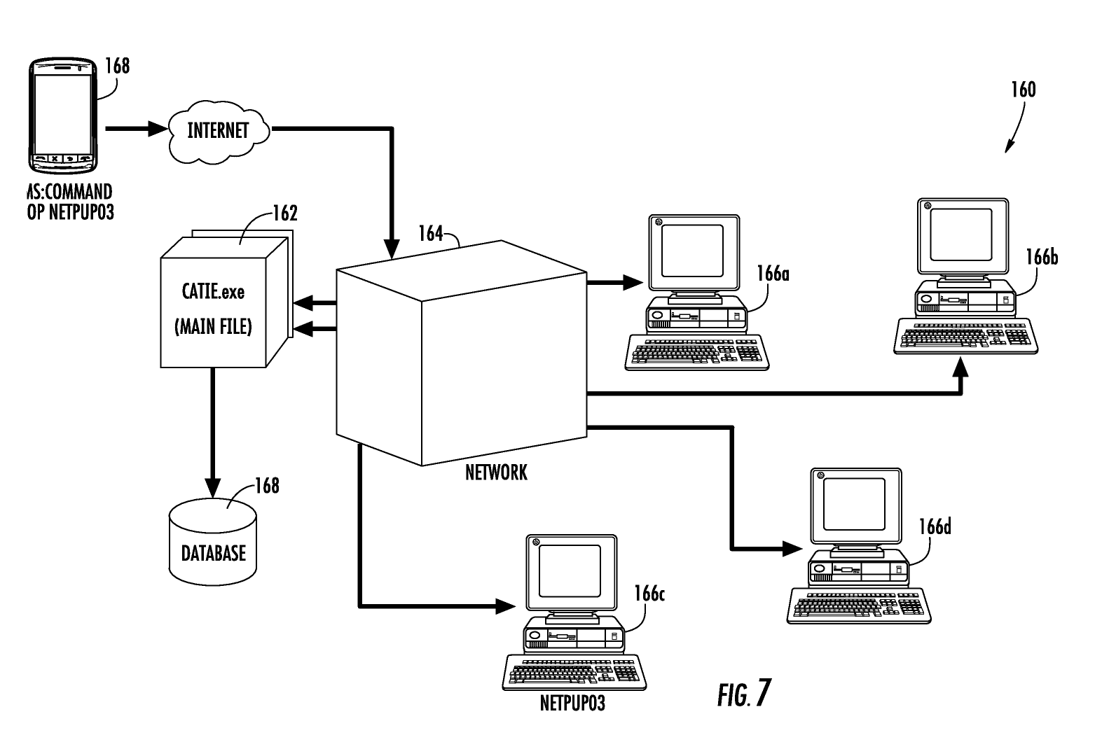

Referring to FIG. 7, as an illustrative example, the user may issue a stop command to netpup#3 using an electronic device (e.g., phone 168) via the network. In some implementations, there may be multiple agents in one building, all running their respective versions of the software, yet netpup#3 may be identified based on the original user's SMS ID number (e.g., entered via global settings or within the ICC). Upon stopping the recording, the screen shot(s) may be stored, etc. In some embodiments, the instructions to start and/or stop may be via text message, SMS, voice (e.g., voice recognition), etc.

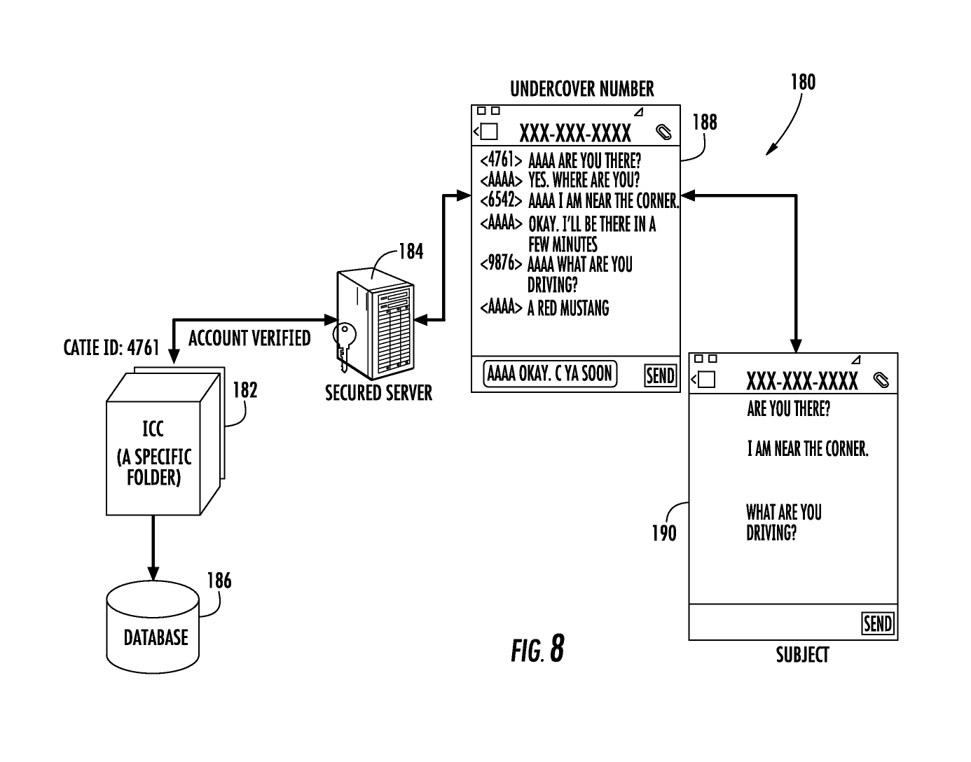

FIGS. 8 through 10 illustrate covert short message service (SMS) as employed by certain embodiments of a computer assisted investigative system. In general, the covert SMS may occur within the executable and/or by using an electronic appliance (e.g., a cell phone device). One or more individuals may participate (or be kept “in the loop”) when sending covert SMS to any one or more subjects or targets (also referred to herein as suspects). The covert SMS may be stored in the main/local user's database for use in a final report at a later date. In contrast, current systems require the agent to use his or her personal cell phone, or purchase a “drop” phone. After the SMS correspondences or communications from the target are complete, the agent (in conventional systems) must use a third-party method to copy or retrieve the SMS from the agent's cell phone generating questions as to the authenticity of such SMS. In contrast, with certain embodiments of computer assisted investigative systems, the information is stored inside the local database, hence removing the need for any third party or any third party methodology and minimizing any authenticity questions.

Referring to FIG. 8, an embodiment of a computer assisted investigative system 180 is depicted, with which an agent may use what is referred to as a “go-phone” or a “drop” phone—it may be a simple cell phone, no camera, no frills, though not limited to these features. The ICC 182 is shown as running a given case and coupled to a secured server 184. The go-phone is to be used, in this example, in covert mode, as the agent does not want the suspect to know his personal phone number (or agency number). The ICC communicates with the same database (186) that is going to go to the secured server, and the 4761 number in the figure is the identification to the computer assisted investigative system software. The suspect is unaware of this number. The screen 188 represents the “undercover” personal phone that the agent does not want the suspect(s) to know about. In screen 188, there is shown an “AAAA,” which represents the suspect. Note, however, that screen 188 is what an agent sees on his phone, but that the suspect does not see. Indeed, since the agent numbers are masked (hidden from view), any attempt by the suspect to contact the agents directly (outside of SMS) results in a hang up (or busy signal, or other mechanism to terminate or render useless any communications by the suspect directly to the agent). The suspect (or subject) sees the screen 190 with the term, “subject” located underneath it.

The agent side of the text messages are displayed next to the “4761” or “AAAA”, etc. in the middle screen capture. The “6542” and “9876” numbers are other agents (like the main agent, alias numbers). The screen capture to the right is what the suspect sees, as noted above. From the suspect's perspective, he (hereinafter, referred to in the masculine, with the understanding that a suspect may be male or female) is thinking that he is only communicating with one individual. However, as observed from the middle screen capture, there exists communication between three different agents talking to the one suspect. In other words, there are multiple agents involved in the communications, all privy to one another (except the suspect). Contrast this feature with existing methods, where agents must communicate back and forth separately (e.g., via radio, phone calls, etc.) to determine whether the suspect has replied or not, and/or whether one agent has sent a text message or not. Thus, the computer assisted investigative systems keep all agents in the loop as to what the suspect is sending and receiving and what each agent is communicating and eliminates the need for any auxiliary or ancillary communications and additionally eliminates the need to extract any communication, data, files, etc. from any one or more of the agents' personal or agency issued phones for evidentiary purposes.

In some embodiments, attempts by the suspect to contact the agent at the number shown on the suspect's phone are logged (e.g., to show intent). There may be canned (e.g., prerecorded) phrases sent to the suspect which may appear as voice mail messages or similar such communication, and those phrases that are sent to the suspect may be selected from a drop down menu listing plural selectable choices (e.g., sent as a file, clipboard, audio file, etc.), obviating the need for the agent(s) to remember particular phrases (though some embodiments may enable the sending of phrases as determined on the fly). Phrases may be maintained in a library, categorized by the targeted suspect and his nefarious activities.

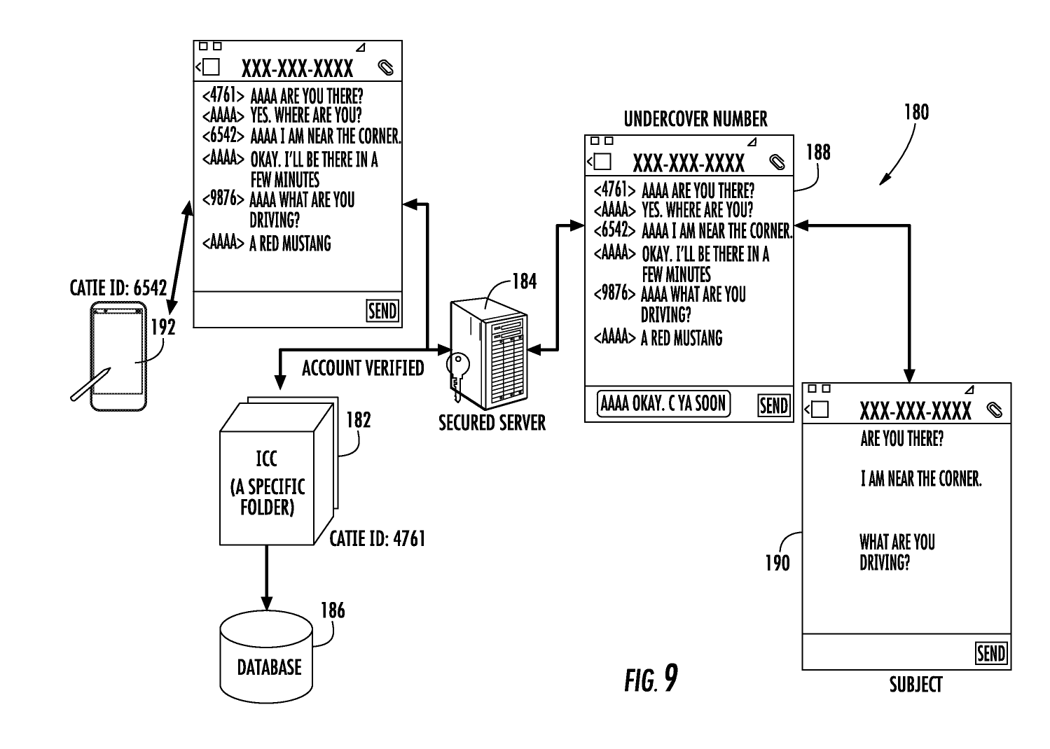

In FIG. 9, what is illustrated in this depicted example is the use of one agent on a phone 192 and another agent in front of a computer running the ICC 182. In other words, some embodiments of a computer assisted investigative systems may utilize different electronic appliances (e.g., computer, smart phone, cell phone, pager, etc.) to provide the messaging from plural agents that the suspect only perceives as coming from the one single same source at a particular number (which is an alias number).

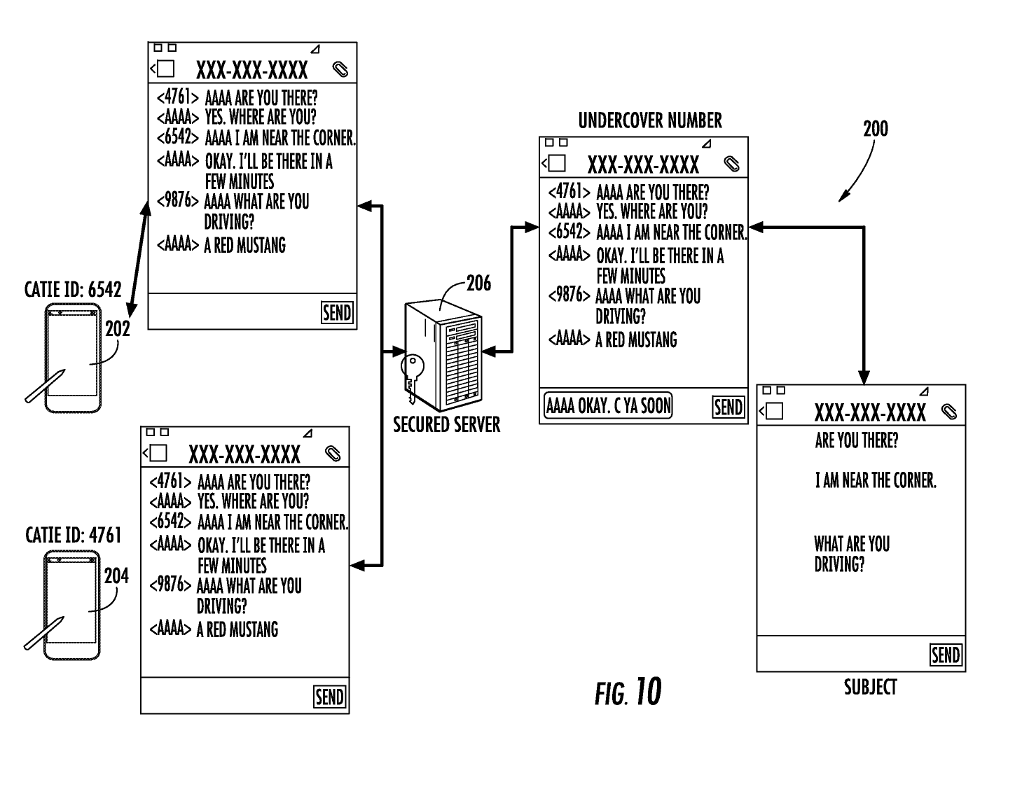

With reference to FIG. 10, in some embodiments, the computer can be bypassed and the functionality may be achieved through the use of cell phones (or other electronic appliances). For example, a computer assisted investigative system 200 of FIG. 10 (wherein no dedicated computer is available for running an ICC), the agent using CATIE's Covert SMS on a mobile device (e.g., device 202 or 204) communicates with a subject and the information is stored in an online data structure (e.g., database) by using server 206. Once the agent re-launches CATIE (catie.exe), the syncing process starts and collects the new information and adds it to the existing data already saved, whether typed data, screen captures, SMS, etc. In general, the information that is logged (e.g., typed data, screen capture, etc.) is channeled, synced or otherwise stored to the centralized database, which can be retrieved at a later date or used for subsequent reports.

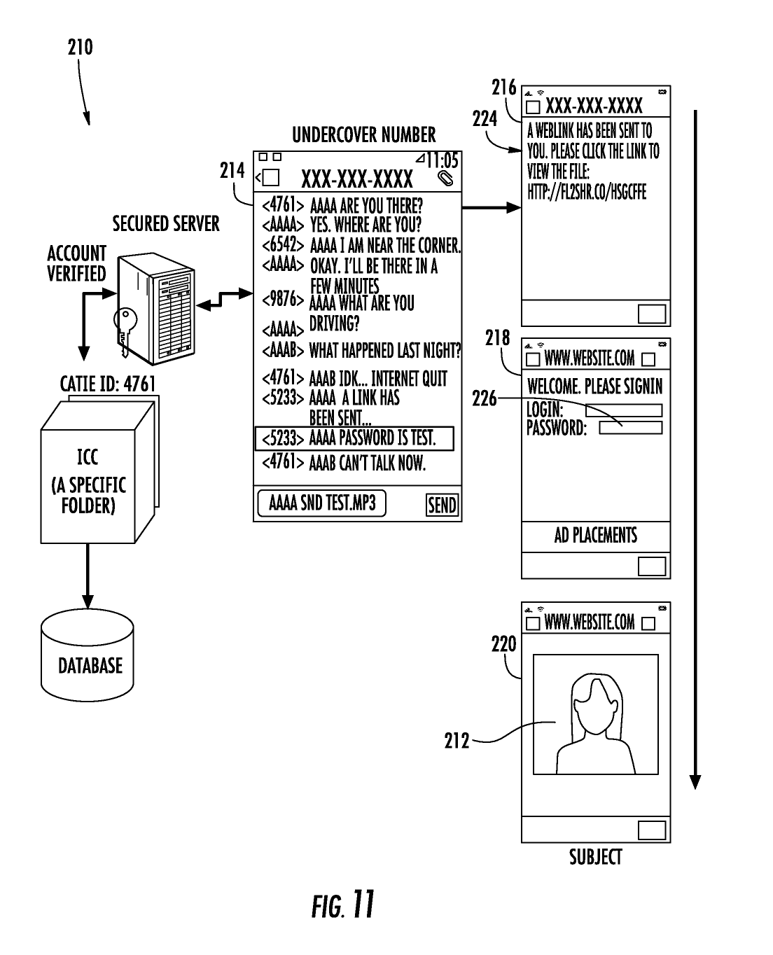

FIGS. 11 through 13A are block diagrams of an embodiment of a computer assisted investigative system for performing undercover Linked Media Service (LMS). In general, certain embodiments of computer assisted investigative systems provide a method for the agent to send “data” to a suspect while the agent is working in an undercover role. When the suspect opens the file or performs an action, the computer assisted investigative system starts a collection or recording process, as described below in association with resource tracking. The data that is sent is protected from discovery by using two different algorithms. In one embodiment, the party it is intended for may only open the data. Current Internet web pages allow users to surf and discover. With one or more embodiments of computer assisted investigative systems, the chances of “accidently” triggering the data tracking would require a person to have searched 36 million x 36 million pages to locate the one piece of data due to the structure created by the computer assisted investigative systems in combination with the algorithms used.

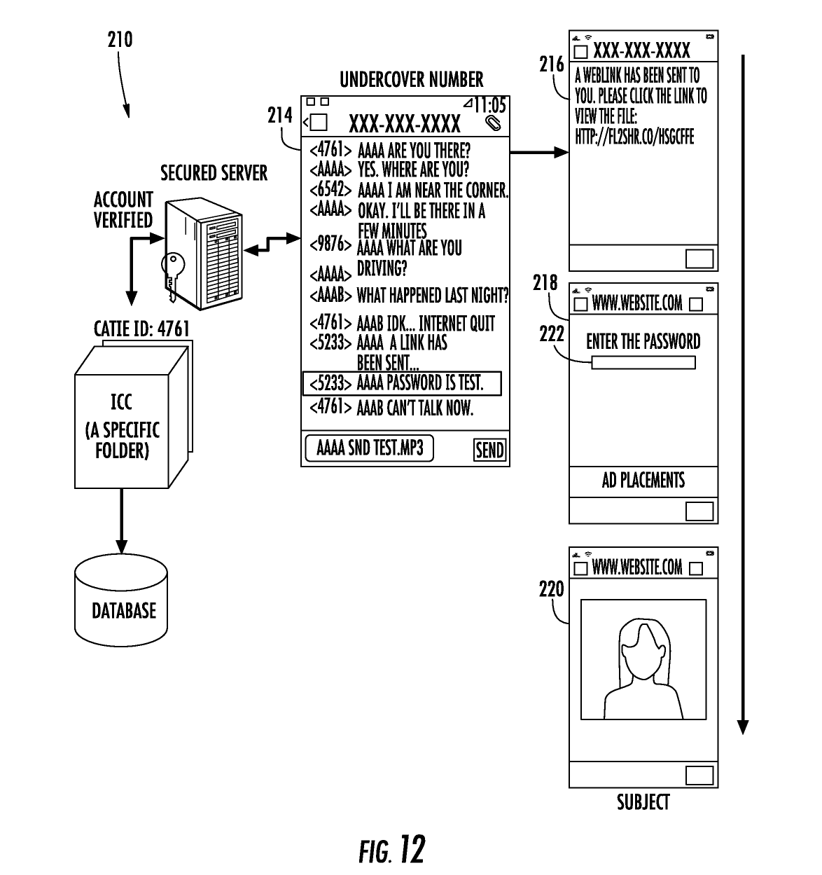

In reference to FIGS. 11 and 12, an embodiment of a computer assisted investigative system 210 is used to send a short URL corresponding to a media file 212 to a suspect, possibly with associated text or a password. For instance, a suspect may wish to see that a “victim's” operation is legitimate, and requests a picture of the inside of the victim's facility. Similarly, pictures of cocaine to be sold, or photos to be shared may also be requested by the suspect. Generally, a dialogue between the agent(s) and the suspect has transpired before the agent sends the link. Note that the agent's screen is represented by screen 214, and the suspect's screen is represented sequentially by screens 216, 218 and 220. An embodiment of the computer assisted investigative system includes the ability for the agent to generate a passcode 222 and require the subject, after clicking on the link, to enter the passcode the agent generated before the data tied to the link can be opened or viewed by the subject (e.g., to confirm the suspect is whom they say they are). The chance of a suspect stumbling onto this link, entering the correct passcode and triggering data tracking comprises approximately 36 million×36 million different combinations due to the structure created by the computer assisted investigative systems in combination with the algorithms used. When the link 224 is opened, the computer assisted investigative system commences tracking (e.g., date and time opened, type of phone, etc.). In some embodiments, the computer assisted investigative system may provide a website 226 to which the suspect can register (e.g., expecting to register on a file sharing program or similar website), after which additional tracking may occur. Accordingly, certain embodiments of computer assisted investigative systems enable suspects to sign up for an account or just enter the passcode generating additional recording and tracking data which can be used by the agents.

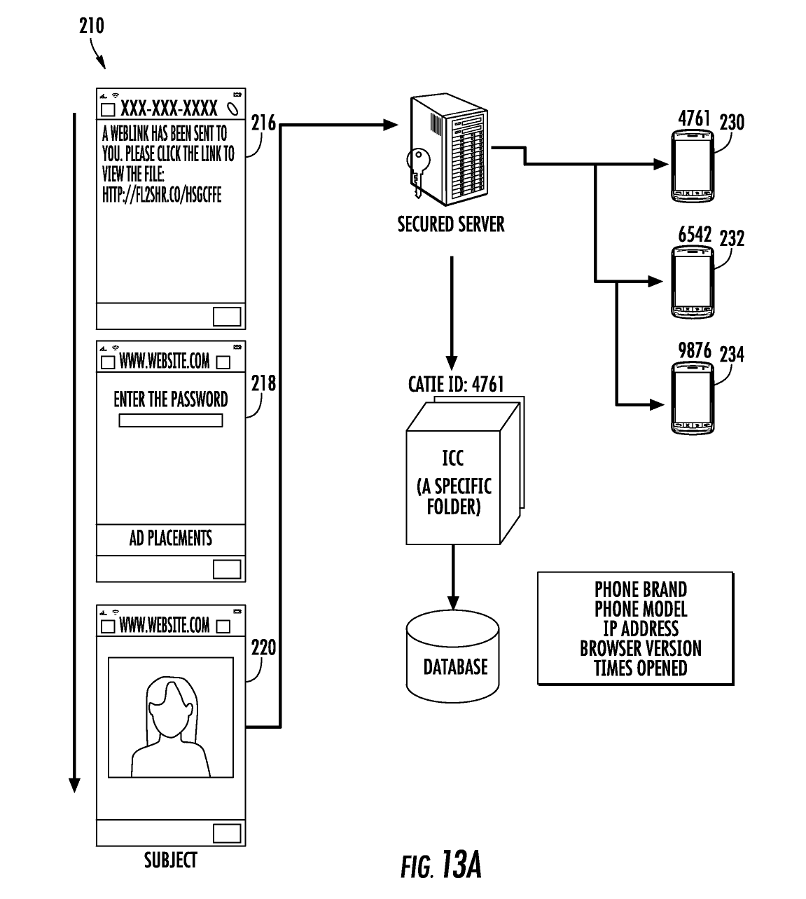

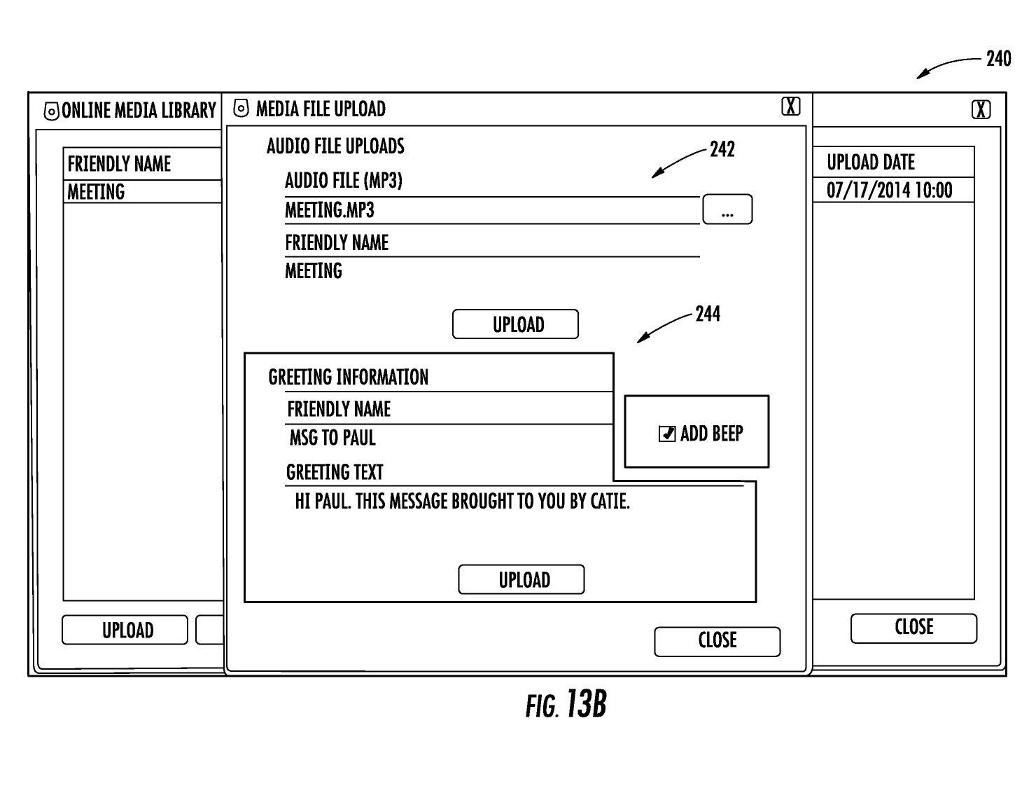

With regard to FIG. 13A, what is illustrated is that, because files are communicated back and forth, when delivered through the secured server and then to the executable, the information now gets disseminated out to other electronic appliances, such as appliances 230, 232 and 234 (e.g., other cell phones or devices associated with other individuals). An agent is notified on his phone that the suspect opened the file, which is particularly important in the case of landline phones. For cell phones, the detection also reveals identifying information, such as the fact that, for instance, the suspect is using an I-Phone with Version 6 software, his IP (e.g., Internet Protocol address, device specific information, etc.), that the link was opened with Safari 6.0, and/or the identity of the image and the computer assisted investigative systems also continues to track and record any additional days and times the link was opened and includes what type of device was used, the IP address, and other device specific information.

In addition to the functionality described above, an embodiment such as that depicted in FIG. 13A may facilitate interaction between multiple agents and a target of an investigation (e.g., a suspect). By way of example, assume that each of the devices 230, 232 and 234 is operated by a different agent and is associated with a different identifier, in this case a unique phone number. Conventionally, if each of the agents were to contact the target using his personal or agency issued device, the target would receive each of the identifiers and readily be able to determine that different people had potentially made the calls. However, in the embodiment of FIG. 13A, the secured server associates a shared identifier (or access number) to each of the devices so that communication between any of the devices and the target results in the target being provided with the shared identifier (e.g., the same telephone number). Thus, multiple agents may use the same shared identifier to provide consistency to an investigation. It should also be noted that, in some embodiments, responsive to the shared identifier being contacted, the system may terminate the communication (e.g., hang-up the call, go directly to voice mail) and inform the agents of the contact by sending a text message to each of the agents indicating that the target attempted communication.

FIG. 13B is a diagram of a representative graphical user interface 240 that may be used in an embodiment of a computer assisted investigative system. In particular, the GUI 240 may be provided by the ICC for use in controlling pre-selected messages (e.g., greetings) to a target device. As shown in FIG. 13B, GUI 240 includes fields 242 for uploading an audio file and fields 244 for uploading text. Once so entered, the files may be communicated to a target device responsive to being contacted by the target and/or in conjunction with the sending of an SMS to the target. This may include playing of the audio file and/or computer reading of the text.

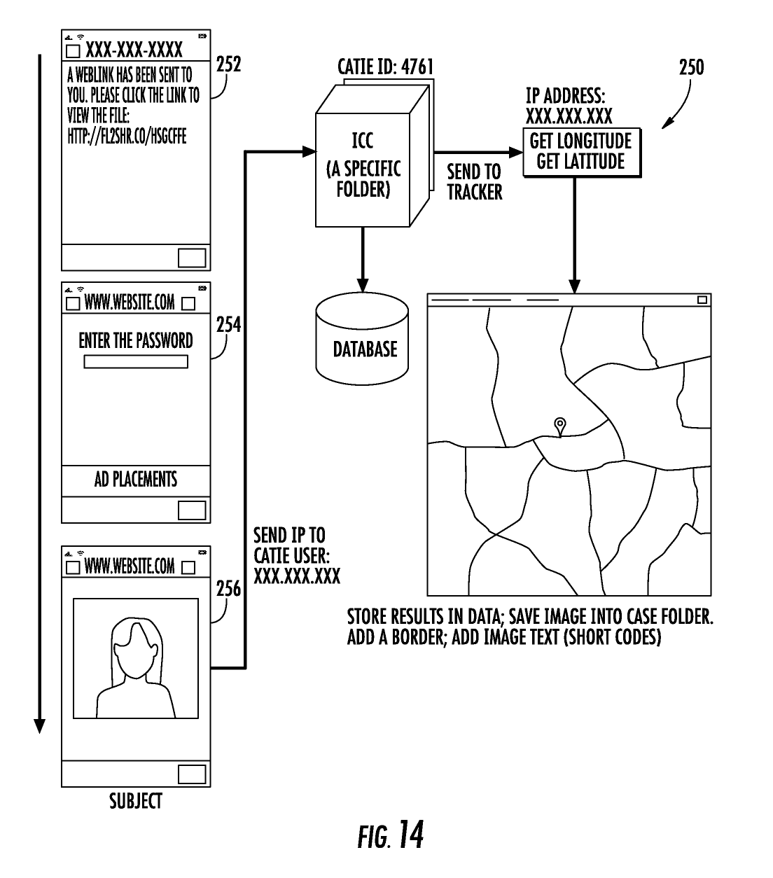

The above-described information accessed from the LMS method in association with FIGS. 11 through 13A can be further processed according to resource tracking functionality associated with certain embodiments of computer assisted investigative systems, as illustrated further in FIGS. 14 through 16. In resource tracking, the actions of a suspect, upon the opening of data, provides a location (e.g., longitude and latitude) to where the suspect opened the data and additional device specific information related to the device used by the suspect to open the data sent by the agents. If the data is sent to a home phone, for example, the data returned represents to the agents that the person answered the phone and therefore is home. Unlike conventional technology, the resource tracking features of computer assisted investigative systems contain two unique identifiers (e.g., derived from two algorithms embodied within the computer assisted investigative system) that tie to each case that is associated with whom the data was delivered.

Referring now to FIG. 14, an agent may use the screen(s) of an embodiment of a computer assisted investigative system 250 to copy the IP, track it, and load it into a map (with repeated iterations to dig deeper into the specifics of the suspect's location). That is, the suspect can take the URL the agent has sent him or her (as depicted in sequential screens 252, 254 and 256) and open it on a computer or other electronic appliance or device, and the opening of the data provides more definition as to where the agent is relative to the suspect's location. Such information can be added to and stored in the case folder. For instance, the computer assisted investigative system can automatically add a line of text, a border, etc. to the location map and automatically adds it to the correct case folder. In some embodiments, also included with the case folder may be an audio file.

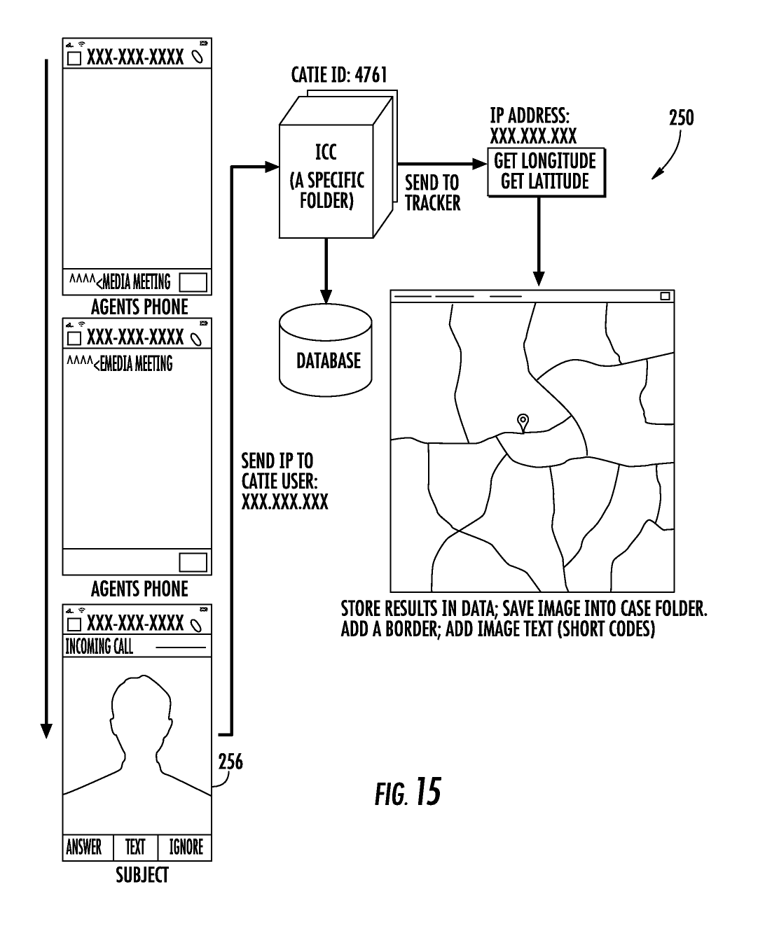

Directing attention now to FIG. 15, the agent may send an audio file, that when opened by the suspect, triggers the tracking processes. For instance, the agent may send a recorded message (e.g., using a library of pre-recorded “messages”), to a suspect and when the suspect answers his/her phone (even if the suspect does not listen to the pre-recorded message), the fact the suspect answered the phone is logged. The IP address is tracked, and based on the IP, the longitude/latitude of the suspect can be determined. If the suspect forwards his or her phone to another number and that is where he answers the phone, the computer assisted investigative system provides that information as well. In practice, suspects generally do not want the phone to ring at work, so he has the phone ring at his desk phone.

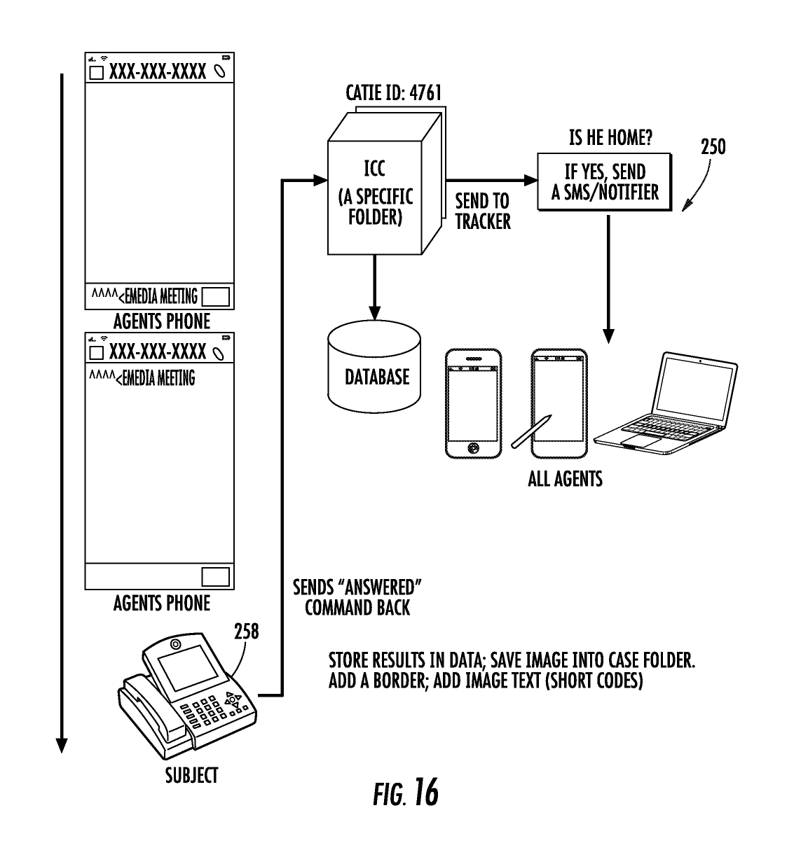

In FIG. 16, the communication is going to a landline phone 258. The computer assisted investigative system still informs the agent, despite the lack of IP, whether the suspect is at home. Right before a search warrant is served, for instance, agents may want to ensure that the suspect is at home. When the suspect picks up the phone and listens to the message, a notification comes back to the computer assisted investigative system to confirm the suspect is at home (i.e., he answered the phone). In some embodiments, the computer assisted investigative system can distinguish between an answering machine or fax machine and a human response. If a fax machine or answering machine is detected, the communication is shut down.

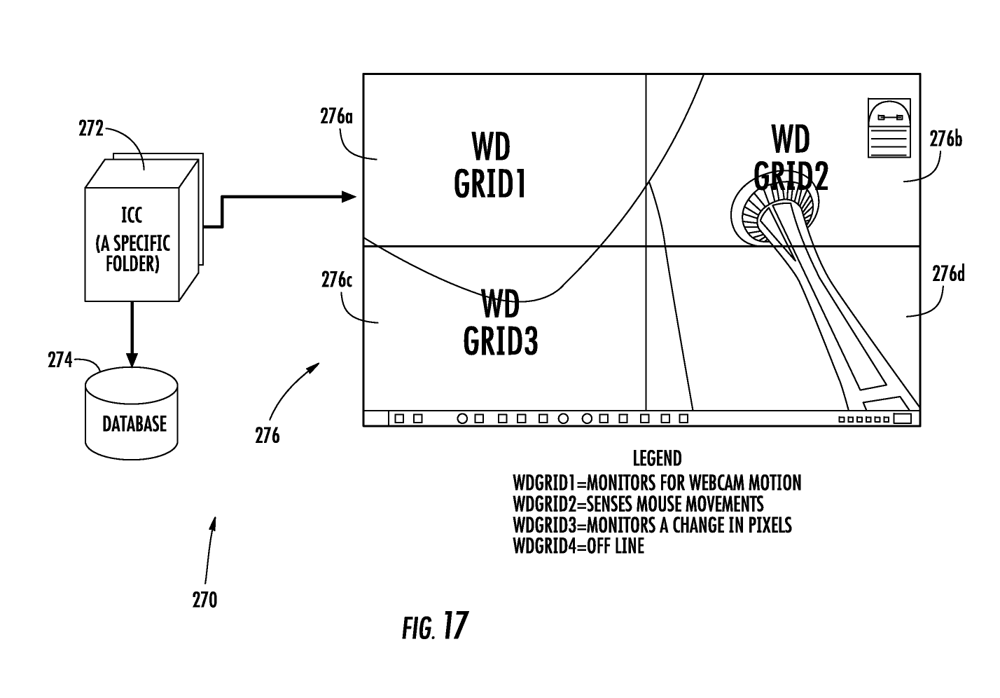

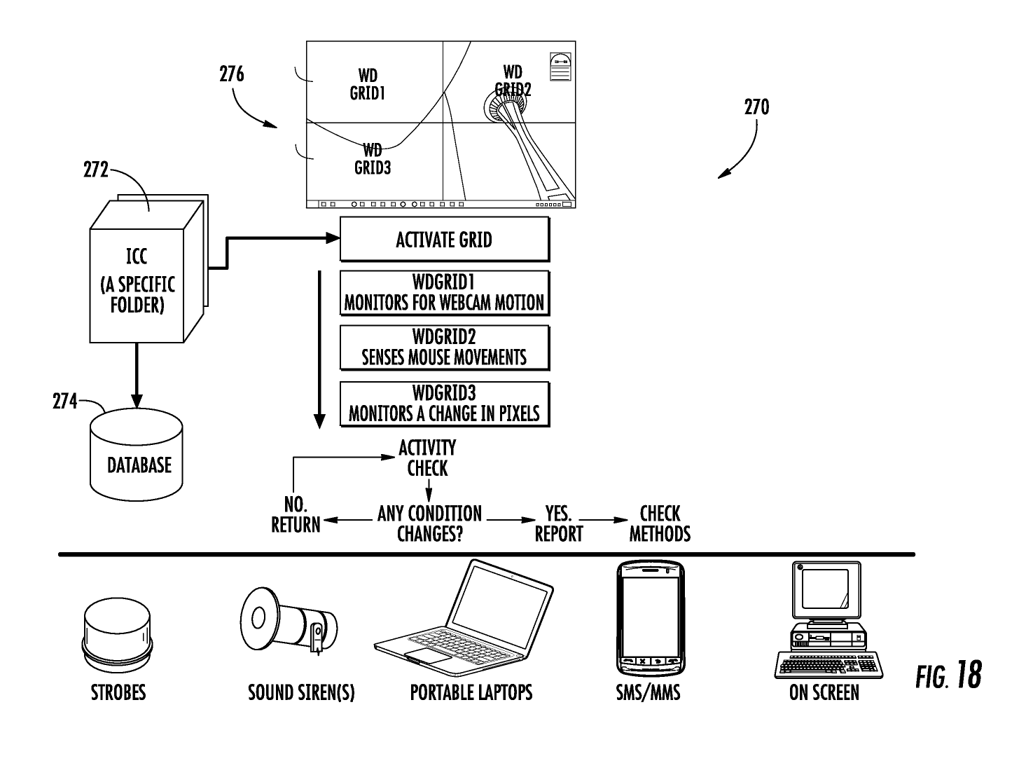

FIGS. 17 and 18 illustrate the Watchdog function of certain embodiments of computer assisted investigative systems. Watchdog generally refers to a grid-based monitoring system that enables custom monitoring by the agent. As shown in FIGS. 17 and 18, system 270 includes an ICC 272, a database 274 and a display 276. The display is divided into an arbitrary grid defining quadrants (or watchdog areas) 276A, 276B, 276C and 276D.

For instance, in operation when an event (e.g., an activity) occurs within a designated watchdog area, the activity immediately triggers a series of actions that automatically occur when the process recognizes the action in its designated area. For instance, in one example, when movement is detected, it is logged (including the image or video capture), and a notification is sent out alerting the agent or agents. As another example, when using a web cam, the web cam may be triggered, causing the capture of the image or video, the logging of the IP, and notification of one or more agents. Law enforcement in general desires to divide a screen (desktop) into quadrants or generally, sections or regions. One reason is that, one quadrant may be used to monitor something going on (e.g., online chatting is being monitored, for instance). What predators will often do is suddenly expose themselves in the middle of a picture and quickly retreat from view (e.g., of the web cam). With the quadrants in mind, there are in general, but not limited to, three different triggering methods that may be employed. If quadrant number 1 (i.e., 276A) is used to monitor the web cam action and the suspect runs into view quickly, the computer assisted investigative system detects the activity, logs the event, captures the image, and sends out a notification (e.g., an alert is sent by email, SMS, or otherwise) to the agent quickly. In some embodiments, there is a threshold percentage of pixel changes that can trigger the recording and alert activity (e.g., based on window size and how much change has occurred within that window), which may be configured (e.g., using a slide bar or other mechanism shown in the art) to adjust the threshold. So, to recap, the event occurrence triggers the logging, image capture, and notification (e.g., alert). In some embodiments, the detected event may trigger capture of the image, logging of the IP, and notification to the agents (and, where employed, performance of resource tracking). With triggering—even with video capture turned off, the agent can configure the system to automatically trigger/activate the recording process, causing the capture of the video and the logging of the IP, etc., which, when combined together, may be used to justify a subpoena to have the provider release the name of the person behind the IP address.

One purpose for the Watchdog functionality is monitoring (e.g., not limited to 4 quadrants by the way, but other configurations may be used, such as 8×8, 4×8, etc.) by designating a screen and deploying different trigger mechanisms for monitoring for web cam(s), mouse movements, or pixel changes in the screen, which may denote action that needs to be taken. And when any action takes place, some embodiments may send an alert to agents, including alerts sent through the use of hardware devices (e.g., red flashing lights, strobes, etc.). For instance, the agent may be sitting in a cube, with a light positioned at the top of his computer monitor, and while away for a cup of coffee or restroom break (or otherwise), the flashing light provides an indication to the agent that an activity has occurred within one or more of the watchdog grids. Similarly, other mechanisms to alert the agent may be used, such as through an electronic appliance (e.g., cell phone, such as a text or tactile alert), audible hardware (e.g., sirens), among others.

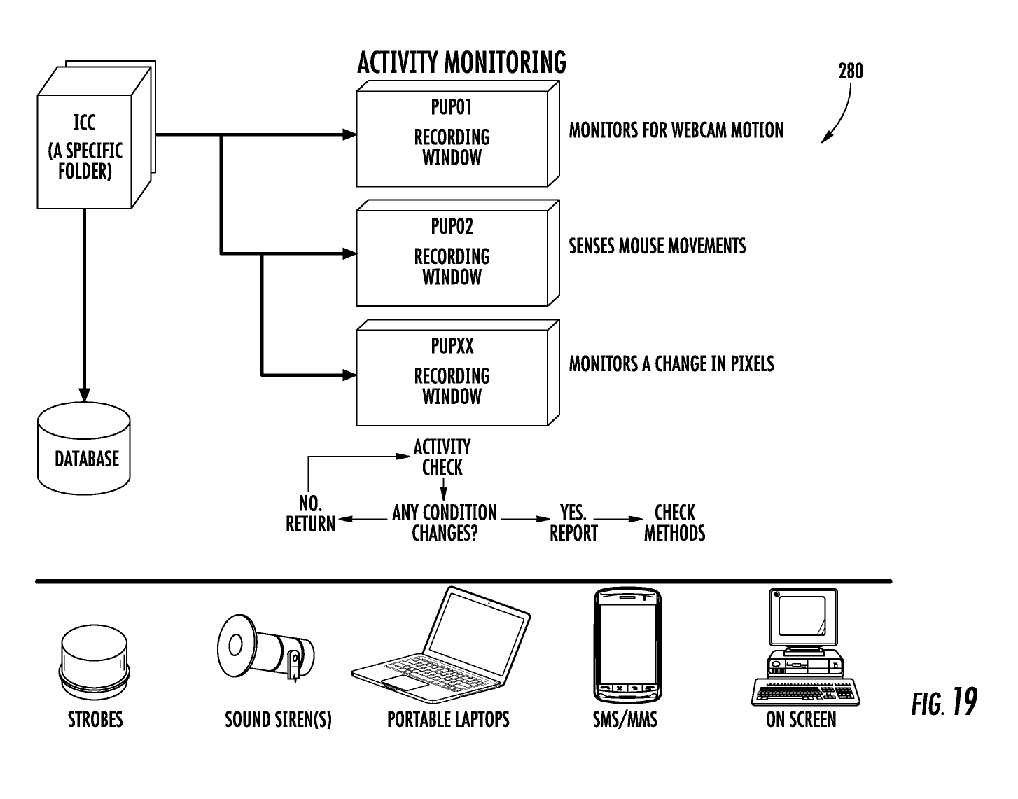

FIG. 19 is a block diagram of an embodiment of a computer assisted investigative system 280 for performing activity monitoring. In activity monitoring, the video, cursor movements, and/or pixel changes are monitored among other motion related or sensor related activities, which can also be monitored. The computer assisted investigative system sets recording of individual windows for activity, and provides notification via text, email, SMS, MMS, etc. The starting and stopping of each video recording window and the monitoring process is performed separately and independently of other video capturing windows that are running. As described earlier, the computer assisted investigative system creates pups. In an activity monitoring mode, the user may configure the system, a computer monitor or a window on the computer monitor, among other such objects to be marked for screen or cursor movement, provide a choice to receive any notification with or without an image, and at what frequency. For instance, the user can configure the system to perform detection of screen changes, with an image, and once every minute transmit notification of any detected change. If the user goes to lunch, the phone is synched back because of the text messaging ability, and as soon as something (e.g., an event) is picked up, a text message of the event is sent to the phone, alerting the agent. The information provided with the indication of detection may include what the picture is and enable selection of the same. Each pup, including, but not limited to a netpup, has its own activity monitoring, and each pup including, but not limited to a netpup, can still be regulated by sending it messages telling it to start and stop. Each pup can watch whatever its activity is, similar to the watchdog functionality, with a difference between the watchdog and activity monitoring being at least that the watchdog is watching the screen as a whole divided by grids. In other words, there is effectively one function over a grid that is doing the monitoring whereas in activity monitoring, there are individual pups and/or netpups.

As to report generation, a given case number, through the above-described monitoring processes, has stored in association with the case a multitude of information, such as screen captures, logged IP addresses that have been traced, date and time, etc. Certain edits may also be automatically performed by the computer assisted investigative system to format, for instance, the screen captures with the addition of borders. For the report, a screen is used to enable the agent to automatically add the subject, table of contents, case details (e.g., keystroke recording, etc.), and select which pictures to add, as well as enable the use of various DOS tools. The agent may determine his or her own IP, copy the same, and allow the system to map it again. In other words, a report is generated based on a simple procedure that can condense what previously took 1-2 months to prepare in a matter of seconds or minutes. The report may include the name, logo of the law enforcement entity or corporation as the case may be, table of contents, the “fake” profile used, IP information, pictures, videos and video information (e.g., frame size, frequency, quantity), etc. The report may be formatted in PDF, html, rtf, and numerous other formats and saved, printed or exported as otherwise needed.

It should be appreciated that certain embodiments may include all or a portion of the above processes, and even additional ones not disclosed above. For instance, in a prosecutor's package, encryption/decryption processes may be used to avoid misuse of data. For instance, law enforcement does an excellent job when they catch child pornographers, and they have thousands of child pornographic pictures. The prosecutor may request those pictures for a case. Generally, law enforcement does not just want to hand that over, because if they do, and it gets lost, the pictures may find their way back into the public domain. So, in a prosecutor's package, the pictures are encrypted, closed, and returned back to the folder, preventing access to the same using unique encryption in combination with other algorithms available only through the computer assisted investigative system and not otherwise available to the public or by conventional means. When the pictures are securely opened, they are decrypted (based on knowledge of the time sensitive, decryption key), and returned to a folder to be viewed. This feature is particularly important for Internet-based access, since if stored on a server, unauthorized access may occur. The login to the computer assisted investigative system requires a password. The system may be set so that for every (or for each) case for which the user is responsible for, he or she may configure the system to encrypt upon closing the case file and decrypt upon securely opening the case file automatically. With the prosecutor's package, the case may be placed on a storage device (e.g., thumb drive, CD, etc.) where access to the contents requires a unique, time sensitive, passcode key, which is generated by the agent on a case-by-case basis and issued by the agent to the prosecutor independent of the data delivered to the prosecutor. In some embodiments, the decryption may have a time limit, after which the encryption returns rendering the data unreadable or inaccessible.

As another example feature present in some embodiments, referred to herein as hide and spy, an imaging device, such as a camera may be equipped with a gyroscope (e.g., to detect movement of the camera) as well as communications abilities (e.g., text messaging)). The device may be provided to banks for insertion in their ATM machines, though other uses are contemplated to track stolen property. For instance, if nefarious persons take the ATM machine, the device detects motion, and sends longitudinal/latitudinal information. When the thieves open the ATM machine, the device automatically takes a picture (e.g., via detection of motion), and sends the picture to the computer assisted investigative system, which then delivers the message and/or picture or an indication thereof to an electronic appliance (e.g., a cell phone). The computer assisted investigative system manages that process (e.g., the text messaging, GPS tracking, etc.) the whole time the ATM has been stolen.

In some embodiments, and related to picture acquisition, authentication and recognition, if there is a need or desire to preserve pictures (potentially to introduce into court as evidence), an image authentication and recognition process can be employed by the computer assisted investigative system executable, which utilizes an encrypted and hidden “Code” (as hereinafter defined) to reveal an image overlay, which the agent applied to the picture, image, video, frame extraction, etc. sent to the suspect. Software on the agent's cell phone or other digital device having a camera (or other such digital device having image creation and/or “recognition” capabilities) or voice recognition/audio recognition capabilities is used to unencrypt and/or unscramble the overlay and display the original image being presented including, (if any), modifications, alterations, or other changes made to the original image by the suspect. Before an agent sends an image to a suspect, the agent selects an image, audio or voice recognition “file” to be used as the hidden overlay, the location placement for the hidden overlay image and then predefines an alpha/numeric or audio code (“Code”), which is used to decrypt the hidden image overlay layer at a later time. By example, the agent's cell phone and accompanying system may be used to recognize and authenticate the hidden image overlay and its location and, thus, authenticate the image as an original. To be more precise, when in court if an agent is requested to authenticate an image being presented as evidence, the agent may turn on and use the camera and associated software system on his cell phone to first “view” or “scan” the image evidence being presented, enter the predefined code for the image, and display the hidden overlay (and, if any, modifications to the original image the agent sent) to the courtroom, thus authenticating the image evidence. If the image evidence displays any modifications, changes, or alterations to the image overlay, then the agent can state that the image evidence being presented was altered and is not the original image evidence sent to the suspect.

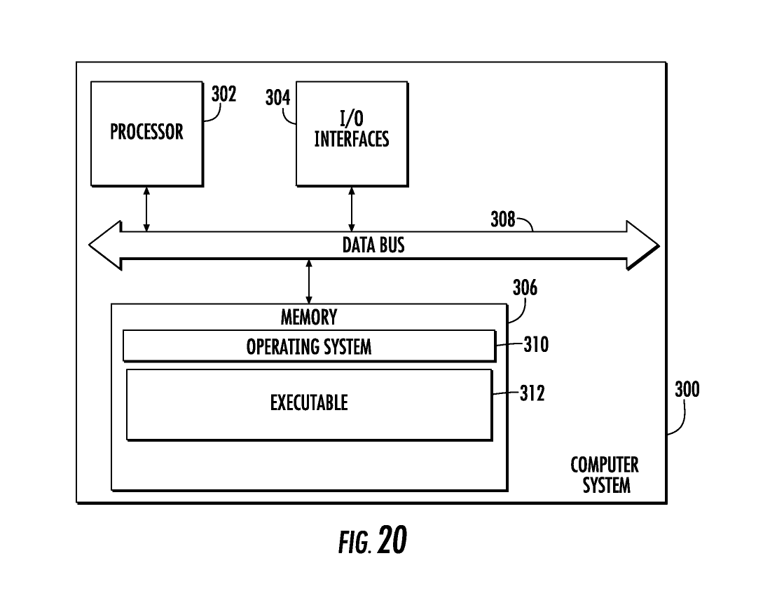

FIG. 20 is a block diagram of an embodiment of a computer system configured to implement a computer assisted investigative system. One having ordinary skill in the art should appreciate in the context of the present disclosure that the example computer system is merely illustrative, and that some embodiments of computer systems may comprise fewer or additional components, and/or some of the functionality associated with the various components depicted in FIG. 20 may be combined, or further distributed among additional modules, in some embodiments. It should be appreciated that certain well-known components of computer systems are omitted here to avoid obfuscating relevant features. In one embodiment, the computer system 300 comprises one or more processors 302 (also referred to herein as processor units or processing units), input/output (I/O) interface(s) 304, and memory 306, all coupled to one or more data busses 308. The memory may include any one or a combination of volatile memory elements (e.g., random-access memory RAM, such as DRAM, and SRAM, etc.) and nonvolatile memory elements (e.g., ROM, hard drive, tape, CD-ROM, etc.). The memory may store a native operating system, one or more native applications, emulation systems, or emulated applications for any of a variety of operating systems and/or emulated hardware platforms, emulated operating systems, etc. In the embodiment depicted in FIG. 20, the memory comprises an operating system 310, and an executable 312. It should be appreciated that in some embodiments, additional or fewer software modules (e.g., combined functionality) may be employed in the memory or additional memory. In some embodiments, a separate storage device may be coupled to the data bus, such as a persistent memory (e.g., optical, magnetic, and/or semiconductor memory and associated drives). The executable is described above, and hence further discussion is omitted here for brevity. Execution of the executable may be implemented by the processor under the management and/or control of the operating system.

The processor may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computer system.

The I/O interfaces provide one or more interfaces to one or more networks, including cellular, local area networks, wide area networks, or a combination thereof. In other words, the I/O interfaces may comprise any number of interfaces for the input and output of signals (e.g., analog or digital data) for conveyance of information (e.g., data) over the network(s). The input may comprise input by an operator (local or remote) through a user interface (e.g., a keyboard, mouse or other input device (or audible input in some embodiments)), and input from signals carrying information from one or more other devices.

When certain embodiments of the computer system are implemented at least in part as software (including firmware), as depicted in FIG. 20, it should be noted that the software can be stored on a variety of non-transitory computer-readable mediums for use by, or in connection with, a variety of computer-related systems or methods. In the context of this document, a computer-readable medium may comprise an electronic, magnetic, optical, or other physical device, digital mechanism or other such apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the computer system are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

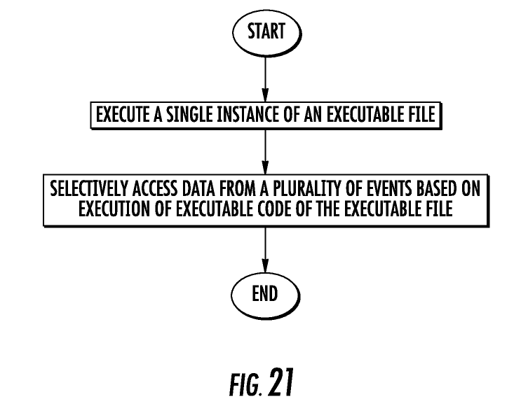

In view of the above description, it should be appreciated that one embodiment of computer assisted investigative method, depicted in FIG. 21, comprises executing a single instance of an executable file; and selectively accessing data from a plurality of events based on execution of executable code of the executable file.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. An investigative system, comprising:
a memory comprising a first executable code; and
a first processor configured to execute the first executable code to:
selectively perform data access from a plurality of events based on execution of the first executable code, wherein the data access corresponds to sequential image capture of the plurality of events using multiple instances of simultaneously executing capture windows.

2. The system of claim 1, wherein the data access corresponds to key stroke recording, and the plurality of events comprise a single type or a plurality of different types of computer software applications.

3. The system of claim 2, further comprising a second processor executing a second executable code to selectively perform data access from a plurality of events based on execution of the second executable code, wherein the data accessed from the first and second processors are stored in a shared database.

4. The system of claim 1, wherein the data is configured for playback as video.

5. The system of claim 4, further comprising a second processor causing the display of at least one of the plurality of events in at least one of the plural capture windows and providing captured images to the first processor.

6. The system of claim 4, further comprising an electronic appliance configured to start and stop at least one of the captures via the first processor.

7. The system of claim 1, further comprising a secured server coupled to the first processor, the first processor in cooperation with the secured server configured to receive, send, and record short message service (SMS) communications between plural cell phones and/or the system or any combination thereof.

8. The system of claim 1, further comprising a secured server coupled to the first processor, the first processor in cooperation with the secured server configured to receive, send, and record linked media service (LMS) communications between plural cell phones and/or the system or any combination thereof.

9. The system of claim 8, wherein the first processor is further configured to prompt as part of the LMS communications a request for authentication.

10. The system of claim 8, wherein a link of the LMS communications corresponds to an audio file.

11. The system of claim 8, wherein the first processor is further configured to commence tracking responsive to receiving an indication that a link of the LMS communications is opened.

12. The system of claim 11, wherein tracking comprises recording one or more of the following: phone or device brand, phone or device model, IP address, browser version, time opened, or date opened.

13. The system of claim 1, wherein data corresponding to the data access comprises an IP address, wherein the first processor is further configured to determine longitudinal and latitude information corresponding to the IP address and optionally store an image of a map corresponding to the longitudinal and latitude information.

14. The system of claim 1, wherein data corresponding to the data access comprises an indication of an answering landline phone, wherein the first processor is further configured to detect whether the answering landline is machine-answered or human-answered.

15. The system of claim 14, wherein the first processor is further configured to provide a notification of the determination and record information corresponding to the notification.

16. The system of claim 1, wherein the first processor is further configured to partition one or more screens with independently monitored regions, wherein responsive to an activity of at least one of the plurality of events in any given region having a predetermined threshold of activity, the first processor is configured to commence a first process corresponding to the data access.

17. The system of claim 16, wherein the first process comprises one or more of the following: detecting the activity in the any given region, recording the activity, logging an IP address corresponding to a location of the activity, capturing the activity, or providing a notification of the activity.

18. An investigative method, comprising:
executing a single instance of an executable file; and
selectively accessing data from a plurality of events based on execution of executable code of the executable file wherein the data corresponds to sequential image capture of the plurality of events using multiple instances of simultaneously executing image capture windows.

19. The method of claim 18, further comprising storing the data in a central repository.

20. The method of claim 18, further comprising:
associating a first agent mobile device and a second agent mobile device with a shared identifier, the first agent mobile device being associated with a first access number for uniquely identifying the first agent mobile device, and the second agent mobile device being associated with a second access number for uniquely identifying the second agent mobile device; and
facilitating communication among the first agent mobile device, the second agent mobile device and a suspect mobile device, the suspect mobile device being associated with a third access number for uniquely identifying the suspect mobile device such that:
communication between the first agent mobile device and the second agent mobile device involves providing the first access number to the second agent mobile device and providing the second access number to the first agent mobile device;
communication between the first agent mobile device and the suspect mobile device involves providing the shared access number to the suspect mobile device and providing the third access number to the first agent mobile device; and
communication between the second agent mobile device and the suspect mobile device involves providing the shared access number to the suspect mobile device and providing the third access number to the second agent mobile device.
